(19) United States
(12) Patent Application Publication
(10) Pub. No.: US 2022/0087116 A1
(43) Pub. Date: Mar. 24, 2022

(54) INDOOR GARDEN CENTER WITH AN ELECTROSTATIC HYDRATION SYSTEM

(71) Applicant: Haier US Appliance Solutions, Inc., Wilmington, DE (US)

(72) Inventors: Matthew R. Hunter, Louisville, KY (US); Brian Michael Schork, Louisville, KY (US); Michael Goodman Schroeder, Louisville, KY (US); Brent Alden Junge, Evansville, IN (US); Richard Devos, Goshen, KY (US); Andrew Scott Hapner, Findlay, OH (US)

(21) Appl. No.: 17/026,381

(22) Filed: Sep. 21, 2020

(51) Int. Cl. A01G 9/26; A01G 27/00; A01G 9/02

(52) U.S. Cl. CPC A01G 9/26; A01G 9/021; A01G 27/008; A01G 27/006

(57) ABSTRACT

An indoor gardening appliance includes a grow module that is rotatably mounted within a grow chamber and that defines pod apertures for receiving a plurality of plant pods. A hydration system includes a discharge nozzle positioned within the grow chamber for selectively discharging a mist of nutrients. An electrostatic charging assembly is coupled to the discharge nozzle for selectively charging the mist of nutrients. By contrast, the plant pods may be electrically coupled to a grounding assembly for selectively grounding the root end of the plant pods. In this manner, the roots of the plants may have an opposing charge relative to the mist of nutrients such that the mist of nutrients are attracted to and deposited on the roots of plants.

### FIELD OF THE INVENTION

The present subject matter relates generally to systems for gardening plants indoors, and more particularly, to a system and method for regulating the hydration of plants in a garden center using an electrostatic hydration system.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Conventional hydration systems for indoor gardens centers provide a flow of water and nutrients onto plants stored therein to facilitate plant growth. For example, typical garden centers have a nozzle that sprays water onto roots within a root chamber of a grow module or otherwise charges the root chamber with mist. However, such hydration systems are typically passive, time-based hydration systems that simply turn on and off at specified times and direct mist from one location within the chamber. As a result, much of the sprayed nutrient and water mixture is misdirected, collects on the walls of the gardening appliance, and/or falls under the force of gravity to the sump where it is discharged through an external drain. As a result, valuable nutrients are wasted, water usage is inefficient, and these garden centers must include high-capacity wastewater management systems or drains.

Accordingly, an improved indoor garden center would be useful. More particularly, an indoor garden center with a nutrient dosing and hydration system that facilitates versatile and efficient hydration dosing would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance is provided, including a liner positioned within a cabinet and defining a grow chamber, a grow module mounted within the liner and defining a pod aperture, the pod aperture being configured for receiving a plant pod, a hydration system comprising a discharge nozzle for selectively spraying a mist of nutrients into the grow chamber, a grounding assembly configured for electrically grounding a root end of the plant pod when then plant pod is inserted through the pod aperture, and an electrostatic charging assembly operably coupled to the discharge nozzle for selectively charging the mist of nutrients such that the mist of nutrients is attracted to the root end of the plant pod.

In another exemplary embodiment, a hydration system for a gardening appliance is provided. The gardening appliance includes a grow module defining a pod aperture for receiving a plant pod. The hydration system includes a discharge nozzle for selectively spraying a mist of nutrients into a grow chamber, a grounding assembly configured for electrically grounding a root end of the plant pod when then plant pod is inserted through the pod aperture, and an electrostatic charging assembly operably coupled to the discharge nozzle for selectively charging the mist of nutrients such that the mist of nutrients is attracted to the root end of the plant pod.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a schematic view of a hydration system that may be used with the exemplary gardening appliance of FIG. 1 according to an exemplary embodiment of the present subject matter.

FIG. 10 provides a schematic view of a hydration system that may be used with the exemplary gardening appliance of FIG. 1 according to another exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

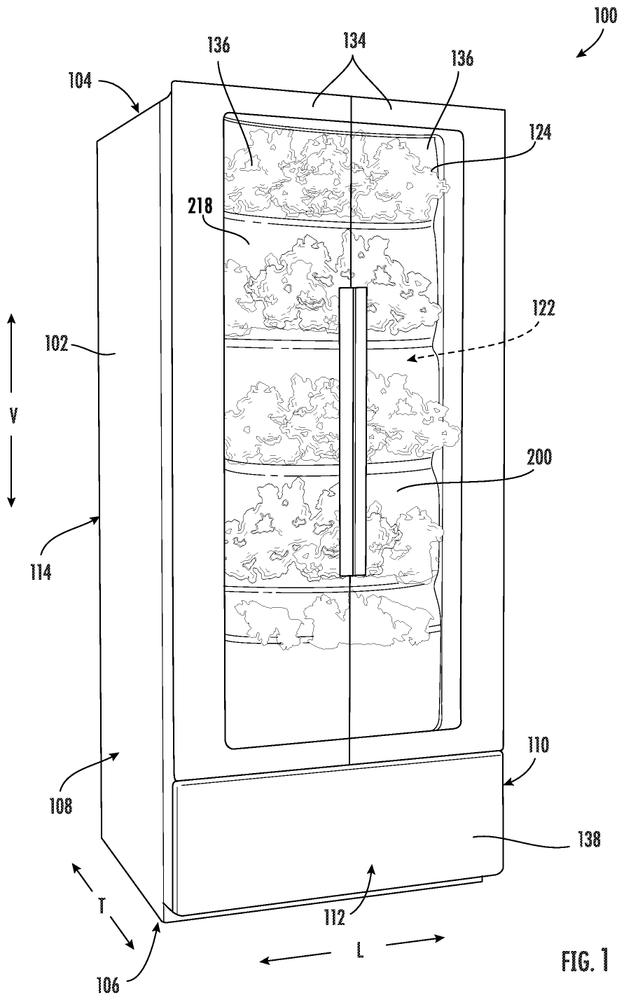

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

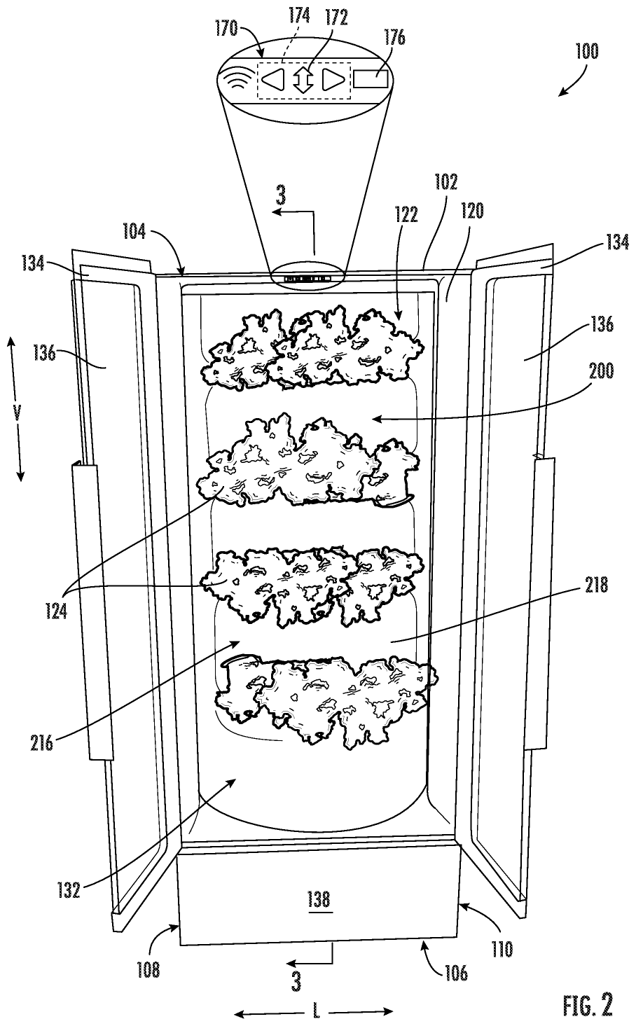

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

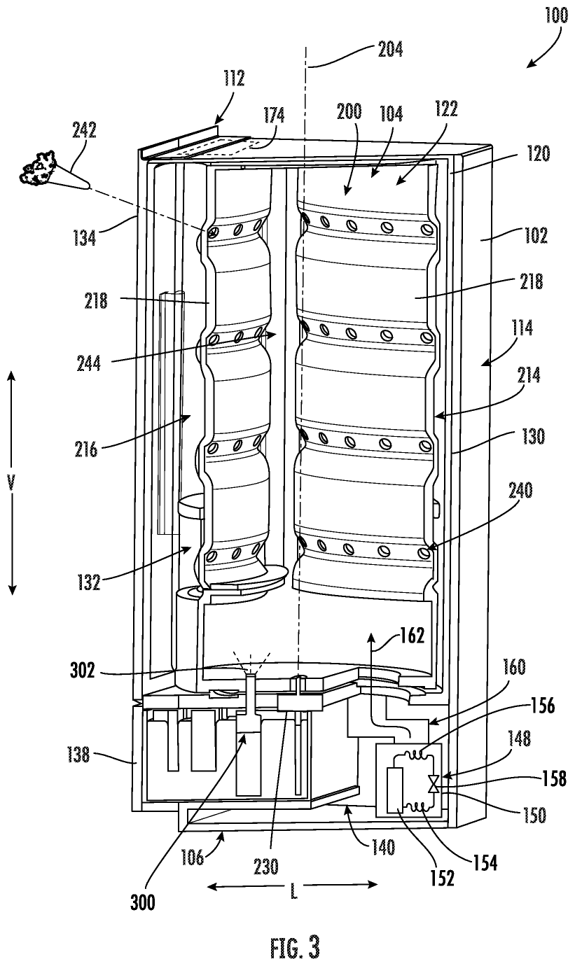

FIG. 3 provides a schematic view of certain components of an environmental control system 148 that may be used to regulate a temperature within grow chamber 122. Specifically, environmental control system 148 may include a sealed system 150, a duct system 160, and a hydration system 300, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

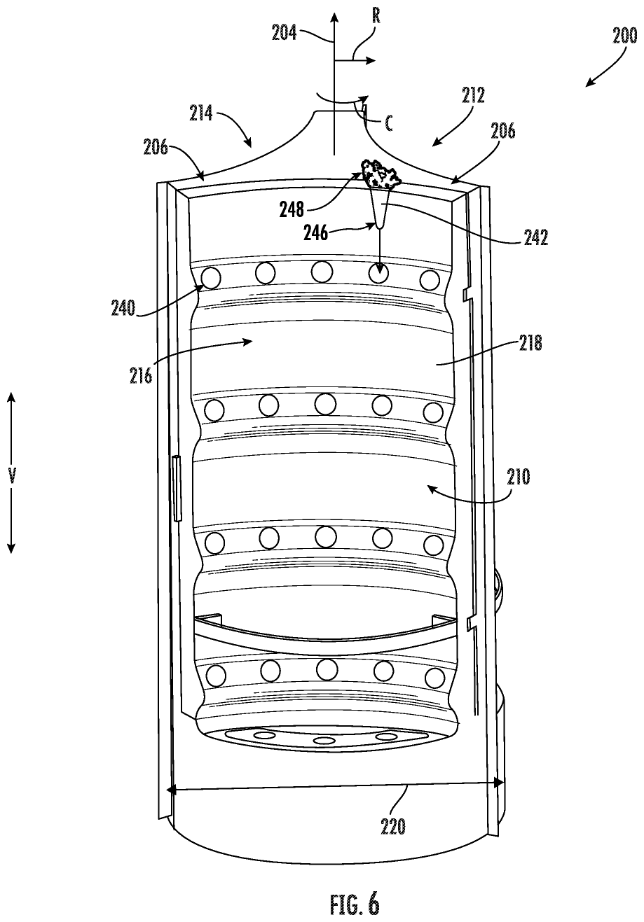

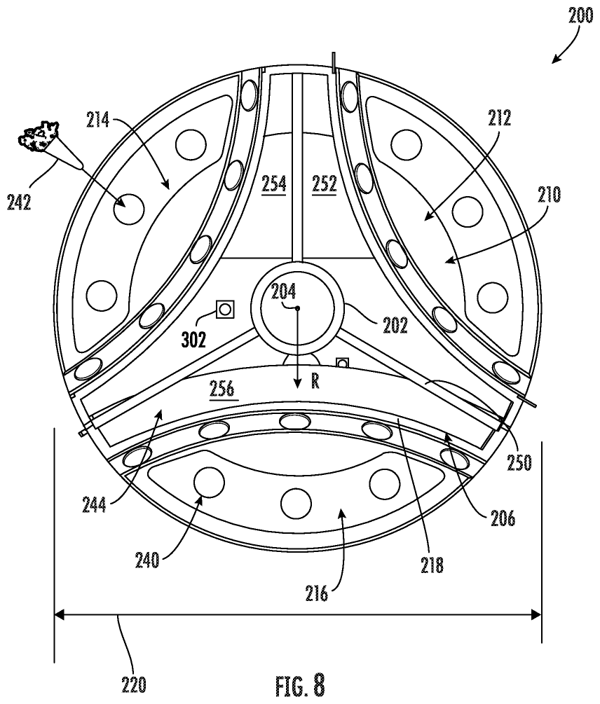

Referring now generally to FIGS. 1 through 8, gardening appliance 100 generally includes a rotatable carousel, referred to herein as a grow module 200 that is mounted within liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. Referring specifically to a first embodiment of grow module 200 illustrated in FIGS. 1 through 8, grow module 200 includes three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition is joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an exemplary embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

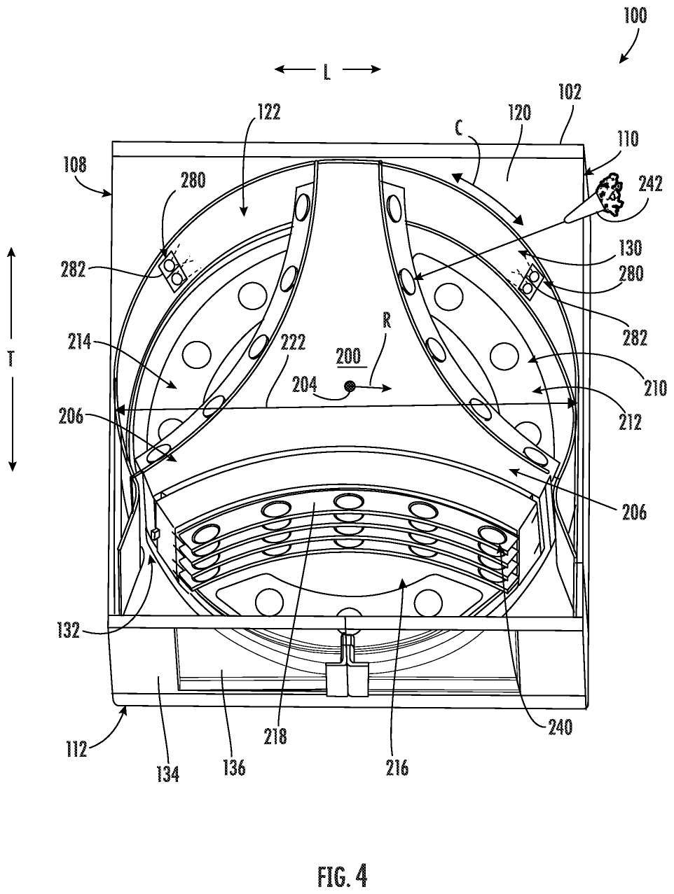

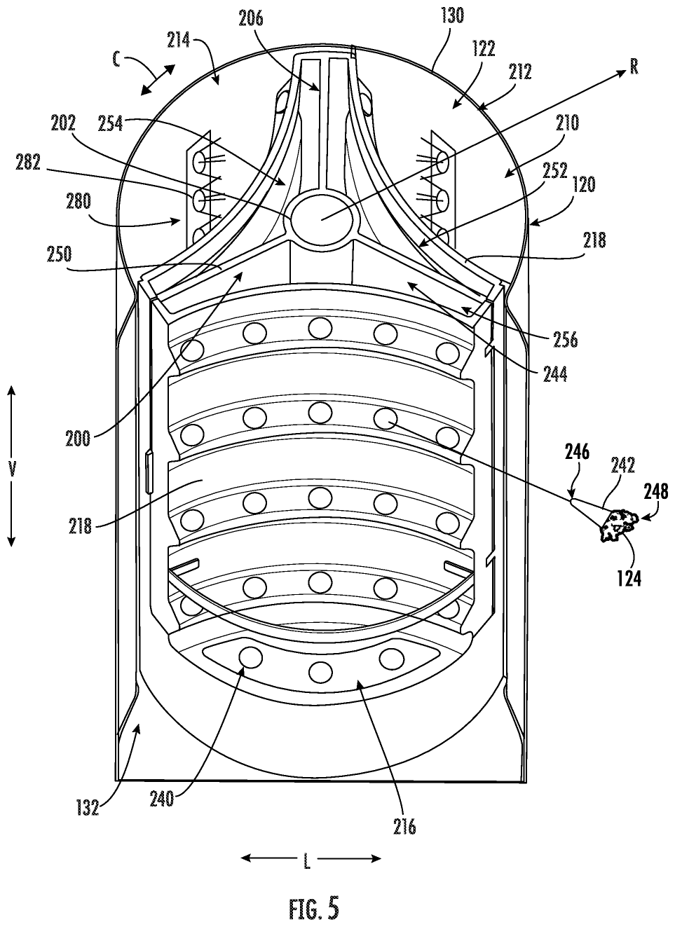

For example, as illustrated in FIGS. 4 and 5, first chamber 212 and second chamber 214 are both in a sealed position, whereas third chamber 216 is in a display position. As motor 230 rotates grow module 200 by 120 degrees in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

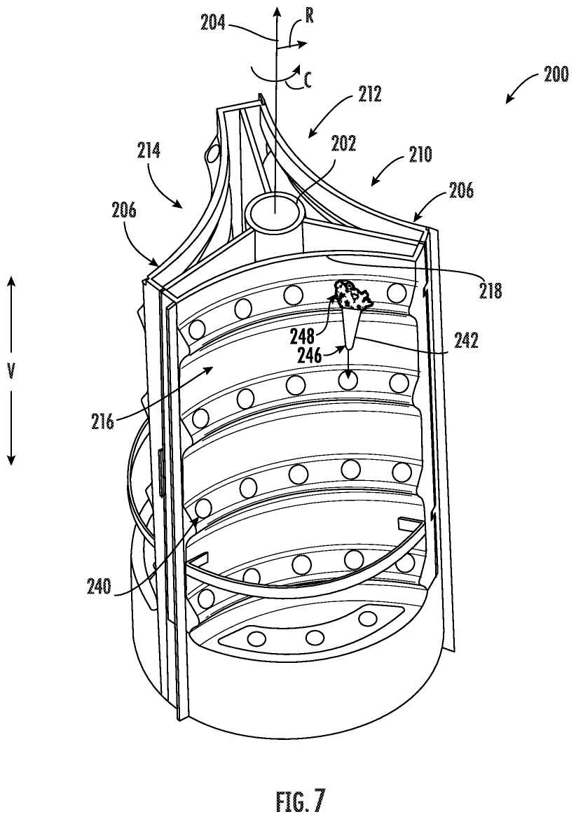

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

As explained above, light generated from light assembly 280 may result in light pollution within a room where gardening appliance 100 is located. Therefore, aspects of the present subject matter are directed to features for reducing light pollution, or to the blocking of light from light sources 282 through front display opening 132. Specifically, as illustrated, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out front display opening 132. As grow module 200 rotates, two of the three grow chambers 210 will receive light from light assembly 280 at a time. According still other embodiments, a single light assembly may be used to reduce costs, whereby only a single grow chamber 210 will be lit at a single time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by 180 degrees about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. As grow module 200 is rotated counterclockwise, first chamber 212 is moved into the display position and third chamber 216 is moved into the sealed position.

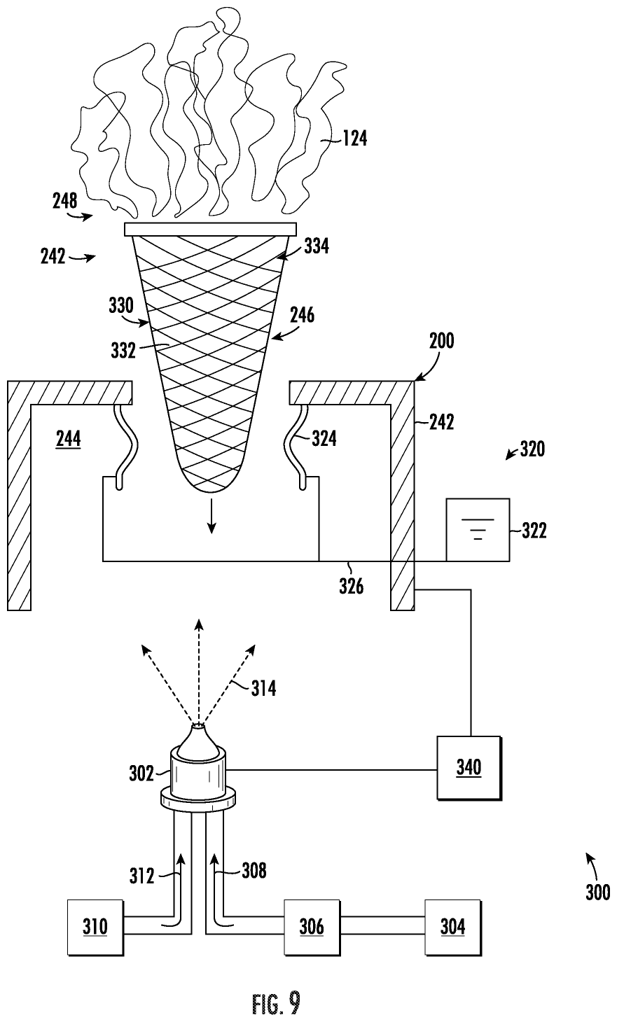

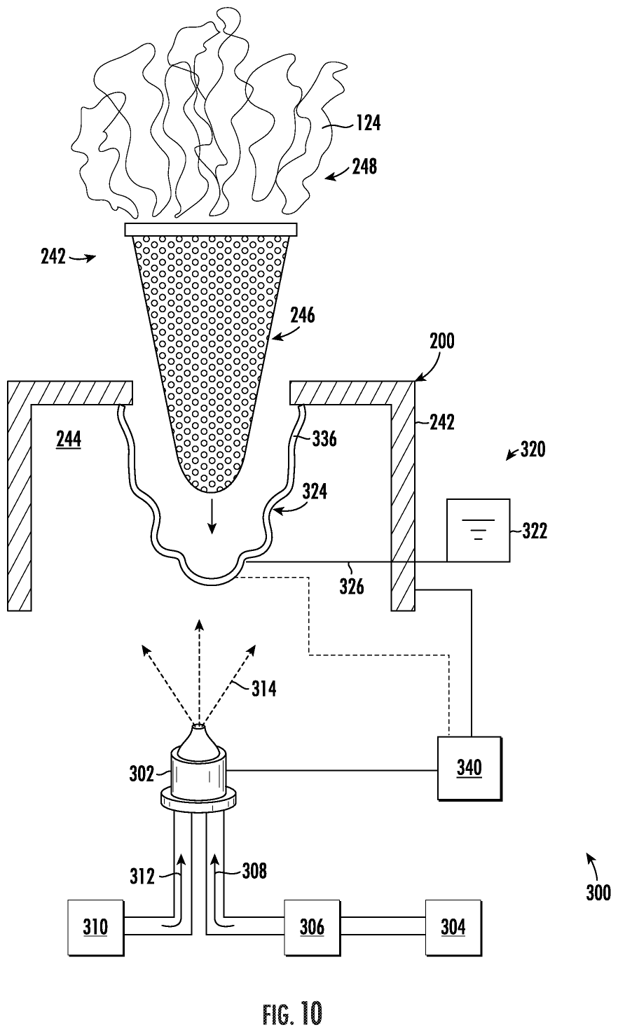

Referring now to FIGS. 9 and 10, a hydration system 300 will be described according to an exemplary embodiment of the present subject matter. In general, hydration system 300 may be used to provide a mist or flow of nutrient rich liquid into grow chamber 122 to facilitate plant growth. For example, continuing the example from above, hydration system 300 may be a part or subsystem of environmental control system 148 of gardening appliance 100. Although hydration system 300 is described herein in the context of gardening appliance 100, it should be appreciated that aspects of the present subject matter may be used to provide hydration and/or nutrients to plants in any other gardening appliance or in any other application where it is desirable to selectively provide desirable quantities and concentrations of hydration, nutrients, and/or other fluids onto plants to facilitate improved plant growth.

FIGS. 9 and 10 provide schematic illustrations of hydration system 300 to facilitate discussion of aspects of the present subject matter. However, it should be appreciated that variations and modifications may be made to hydration system 300 while remaining within the scope of the present subject matter. For example, grow module 200 may take any other form and may have any other suitable number and size of apertures. In addition, any other suitable size, number, and orientation of discharge nozzles may be used. Moreover, the plumbing configuration for providing flows of water, air, and/or nutrients to hydration system 300 may vary.

In general, hydration system 300 includes a discharge nozzle 302 (e.g., such as a fine mist spray nozzle or nozzles) that is fluidly coupled to a water supply, such as a mixing tank 304. According to the illustrated embodiment, mixing tank 304 is supplied with the desired mixture of water and/or nutrients for optimal growth of plants 124. It should be appreciated that mixing tank 304 may itself be fluidly coupled to a water supply (not shown), such as a reservoir containing water (e.g., distilled water) or a municipal water supply. In addition, mixing tank 304 may be fluidly coupled to a nutrient dispensing assembly (not shown) that may be provide the desired amount or concentration of nutrients within mixing tank 304.

Hydration system 300 may further include a liquid pump 306 that is fluidly coupled to mixing tank 304 and is configured for directing a flow of nutrients 308 into discharge nozzle 302. In addition, according to an exemplary embodiment, hydration system 300 includes an air pump 310 or another suitable pressurized air source for providing a flow of air 312 to discharge nozzle 302. Discharge nozzle 302 is generally configured for receiving the flow of nutrients 308 and the flow of air 312 and generating a mist of nutrients (e.g., identified herein by reference numeral 314). Specifically, discharge nozzle 302 selectively discharges nutrients in a high pressure, atomized, and/or ionized mist with droplets that are optimally sized for root absorption. Any suitable type and configuration of nozzle may be used to generate a mist 314 containing droplets that are carefully sized to be small enough where the force of gravity is mostly offset by the viscous forces of the air and the droplets are more or less neutrally buoyant. In addition, these droplets may be optimally sized for easy uptake by the roots of the plants.

Discharge nozzle 302 may be positioned at any suitable location within grow chamber 122, such as at a top of root chamber 244. Alternatively, hydration system 300 may include a plurality of discharge nozzles 302 spaced apart along the vertical direction V within each of root chambers 252-256. According to exemplary embodiments, hydration system 300 may include any suitable number, type, and position of discharge nozzles 302 for improving the distribution of the mist of nutrients 314. It should be appreciated that discharge nozzle 302 is configured for generating the mist of nutrients 314 that includes a high pressure atomized and ionized fluid or mist including both water and/or nutrients. In this manner, discharge nozzle 302 charges root chamber 244 with mist 314 for hydrating the roots of plants 124.

Notably, aspects of the present subject matter are directed towards selectively charging certain liquids, surfaces, objects, or features within gardening appliance 100 and create electrostatic charges that urge the mist of nutrients 314 onto the desired plants or locations within gardening appliance 100. As used herein, the terms “electrostatic charge,” “charge,” and the like are generally intended to refer to an excess or deficiency of electrons on the surface of a liquid, object, structure, or material. For example, the electrostatic charge of water droplets, nutrients, grow module walls, and plant roots may be generally quantified by referring to their electrostatic charge or relative charge. It should be appreciated that objects with similar charge tend to repel each other, while objects with opposite charges tend to attract each other. Aspects of the present subject matter are directed to selectively charging various sprays, mists, roots, or other objects within gardening appliance 100 to manipulate the relative attraction or repulsion between various objects and improve plant hydration while minimizing wastewater. The terms “charging,” “discharging,” and the like are used generally herein to refer to the manipulation of the electrostatic charge of an object, not necessarily to the absolute magnitude of the charge of a particle or object. In addition, although the terms “positive charge” and “negative charge” are used herein to describe the relative charges of objects and the level of attraction between them. It should be appreciated that according to exemplary embodiments, these charges may be reversed or adjusted without departing from the scope of the present subject matter.

According to an exemplary embodiment, hydration system 300 may include a grounding assembly 320 that is configured for electrically grounding root end 246 of plant pod 242 when plant pod 242 is inserted through pod aperture 240. It should be appreciated that grounding assembly 320 may use any suitable number of features, electrical contacts, or other devices for electrically grounding root end 246 of plant pods 242. In this manner, the roots of plants 124 that are in contact with the root end 246 are also electrically grounded.

For example, as shown in FIG. 9, grounding assembly 320 includes an electrical ground 322 that is electrically coupled with a grounding contact 324, e.g., via grounding wires 326. For example, according to the illustrated embodiment, grounding contact 324 is a spring-loaded copper contact positioned adjacent pod aperture 240 that slides against plant pod 242 when it is inserted. In addition, plant pod 242 is formed at least partially from a conductive contact 330. When plant pod 242 is inserted through pod aperture 240, conductive contact 330 is configured for contacting and electrically coupling root end 246 of plant pod 242 with grounding contact 324 and electrical ground 322. In this manner, when plant pod 242 is inserted into pod aperture 240, grounding assembly 320 ensures that root end 246 of plant pod 242 is grounded or has a neutral charge. According to still other embodiments, grounding assembly 320 may be configured for charging plant pod 242 in any other suitable manner to have any other charge suitable for attracting mist of nutrients 314. It should be appreciated that grounding contact 324 may include any other suitable number and type of conductive structures for making electrical contact with plant pods 242.

According to the illustrated embodiment, such as illustrated for example in FIG. 9, conductive contact 330 is a wire mesh screen 332 that forms root end 246 of plant pod 242. In this manner, the roots of plants 124 grow through and around wire mesh screen 332 and are in direct electrical contact with wire mesh screen 332. According to exemplary embodiments, wire mesh screen 332 is formed using a highly conductive material, such as copper. In addition, according to exemplary embodiments, root end 246 of plant pod 242 may be coated with a conductive paint 334 or other material that ensures root end 246 has an electrical conductivity suitable for permitting grounding assembly 320 to adjust its level of electrostatic charge.

According to still other embodiments, such as shown in FIG. 10, conductive contact 330 may be a pod receptacle 336 that is attached to grow module 200 and is adjacent pod aperture 240 for receiving plant pod 242. Pod receptacle 336 may be operably coupled to grounding assembly 320 (e.g., via a grounding wire 326) such that the electrical charge of pod receptacle 336 may be adjusted by grounding assembly 320. Notably, when plant pod 242 is inserted through pod aperture, root end 246 may be in direct electrical contact with pod receptacle 336 such that grounding assembly 320 also controls the electrostatic charge of the roots of plants 124.

Although grounding assembly 320 is described herein as electrically grounding or providing a neutral charge to root end 246 of plant pods 242, it should be appreciated that according to alternative embodiments, grounding assembly 320 may only partially electrically ground root ends 246 or may otherwise adjust or regulate the electrostatic charge of root end 246 in any other suitable degree to increase or decrease the repulsive or attractive forces between root end 246 and the mist of nutrients 314.

According to exemplary embodiment, hydration system 300 includes other features for selectively charging the mist of nutrients 314. In this manner, by regulating the relative charges between the mist of nutrients 314 and the roots or root end 246 of plant pods 242, the attractive and repulsive forces between the mist of nutrients 314 and plants 124 may be regulated to improve the distribution or flow of mist of nutrients 314 within grow chamber 122. In this regard, for example, hydration system 300 includes an electrostatic charging assembly 340 that is operably coupled to discharge nozzle 302 for selectively charging mist of nutrients 314 as it is discharged from discharge nozzle 302. For example, electrostatic charging assembly 340 may provide a positive charge to mist of nutrients 314 such that the mist of nutrients 314 is attracted to the grounded root end 246 of plant pod 242, which has a neutral or grounded charge as a result of grounding assembly 320.

In general, electrostatic charging assembly 340 may be any device or system of devices suitable for charging a mist of nutrients 314 flowing through discharge nozzle 302. For example, electrostatic charging assembly 340 and discharge nozzle 302 may include one or more electrostatic sprayers that operates by using an electrode to attract electrons from the mist of nutrients 314 exiting discharge nozzle 302, thereby positively charging the droplets exiting discharge nozzle 302 (i.e., the mist of nutrients 314). These charged droplets repel one another and are attracted to neutral or oppositely charge surfaces, such as grounded plant roots, where the charged droplets coat the roots on all sides and in a uniform manner for optimal hydration. The charged droplets are also resistant to pooling and are repelled from undesirable surfaces, such as other positively charged surfaces within gardening appliance 100.

Although electrostatic charging assembly 340 is described herein as providing a positive charge to mist of nutrients 314 and grounding assembly 320 is described as providing a neutral or ground charge to root end 246 of plant pods 242, it should be appreciated that these charges may be altered or varied according to other embodiments. For example, electrostatic charge assembly 340 may provide only a slight positive charge while grounding assembly 320 may only partially ground root end 246, such that the relative difference in electrostatic charge and the resulting attractive force between mist of nutrients 314 and plant pods 242 is relatively low. This may be desirable, for example, when a particular plant 124 is more drought tolerant or otherwise requires less liquid nutrients. By contrast, for mature plants or plants that require large amounts of nutrients, electrostatic charging assembly 340 may generate a strong positive charge on the mist of nutrients 314 and grounding assembly 320 may fully ground root end 246, resulting in a strong attraction between mist of nutrients 314 in root end 246.

According to exemplary embodiments (e.g., as illustrated for example in FIG. 10), electrostatic charging assembly 340 may be directly coupled to plant pod 242 to selectively charge root end 246. In this manner, if a plant 124 is not in need of nutrients, electrostatic charging assembly 340 may provide a positive charge to the roots of selected plants 124, thereby repelling mist of nutrients 314 from the selected plants such that the mist may be more appropriately and efficiently used to hydrate plants that actually need the hydration (which may be more oppositely charged). In this manner, by regulating the relative charges of root end 246 of various plants 124 relative to the charge of the mist of nutrients 314, hydration system 300 may optimally distribute mist of nutrients 314 where it is needed most within gardening appliance 100.

Moreover, according to exemplary embodiments, electrostatic charging assembly 340 may be electrically coupled to one or more walls 342 of grow module 200 for selectively charging the walls 342 of grow module 200. In this manner, mist of nutrients 314 is repelled from walls 342 and is directed more toward plants 124. It should be appreciated that other surfaces, features, and portions of gardening appliance 100 may also be similarly charged by electrostatic charge assembly 340. Indeed, any or all surfaces of gardening appliance 100 and/or plants 124 may be selectively charged by electrostatic charge assembly 340 and/or grounded by grounding assembly 320 to create a system of repelling an attractive forces between mist of nutrients 314 and desired locations within gardening appliance 100. In this manner, plants 124 may receive the optimal amount of nutrients while wastewater is minimized.

The systems and methods described above use relative electrostatic charges between water/nutrients and plants to improve hydration and aeroponic efficiency of indoor garden centers. By contrast, typical indoor plant growing appliances have excess water that needs to be either disposed of by draining or reused to water the plants. Improving aeroponic efficiency results in a reduction of the amount of water and nutrients that need to be supplied to the plants and a reduction of necessary subsystems and processing to deal with drained wastewater. Specifically, the presently disclosed hydration system may use electroponics, i.e., a system that creates an ionized stream of water particles that are not attracted to each other and are attracted to plant roots. The droplets are carefully sized to be small enough where the force of gravity is mostly offset by the viscous forces of the air and the droplets are more or less neutrally buoyant. Fortunately, the droplets may also be sized for easy uptake by the roots of the plants. These small ionized droplets are then attracted to surfaces that are grounded and thus uncharged or neutrally charged.

For example, a wire basket may be used to hold and ground the roots and an opposite charge could be generated on the walls of the grower to repel the water droplets and reduce the chance of them landing where they would create waste. The ground mesh for each pod could be controlled or switched, e.g., such that plants furthest away from the sprayer could be grounded whereas the ones closest might not be grounded or grounded as well. This could even the nutrient distribution. Selective plants could be grounded when a certain nutrient is sprayed and other plants may remain ungrounded or charged to repel moisture. This could be used to help get the right nutrient to the right plant or to avoid overwatering new plants while delivering more water to mature plants to continue their growth. This system provides additional benefits in the event of a system that recirculates drained water. For example, if the nutrient liquid is recirculated, the electrostatic charging might kill any bacteria or mold in the water. Other benefits of such a system will be apparent to one of ordinary skill in the art.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance, comprising:
a liner positioned within a cabinet and defining a grow chamber;
a grow module mounted within the liner and defining a pod aperture, the pod aperture being configured for receiving a plant pod;
a hydration system comprising a discharge nozzle for selectively spraying a mist of nutrients into the grow chamber;
a grounding assembly configured for electrically grounding a root end of the plant pod when then plant pod is inserted through the pod aperture; and
an electrostatic charging assembly operably coupled to the discharge nozzle for selectively charging the mist of nutrients such that the mist of nutrients is attracted to the root end of the plant pod.

2. The gardening appliance of claim 1, wherein the plant pod is formed at least partially from a conductive contact, and wherein the grounding assembly further comprises:
a grounding contact positioned adjacent the pod aperture for contacting the conductive contact of the plant pod when the plant pod is inserted through the pod aperture.

3. The gardening appliance of claim 2, wherein the conductive contact comprises a conductive wire mesh for receiving the root end the plant pod.

4. The gardening appliance of claim 2, wherein the conductive contact comprises a conductive paint deposited on the root end of the plant pod.

5. The gardening appliance of claim 1, further comprising:
a pod receptacle attached to the grow module adjacent the pod aperture for receiving the plant pod, the pod receptacle being operably coupled to the grounding assembly.

6. The gardening appliance of claim 5, wherein the grounding assembly comprises:
a grounding wire electrically coupling the pod receptacle to an electrical ground.

7. The gardening appliance of claim 1, wherein the electrostatic charging assembly is electrically coupled to one or more walls of the grow module for selectively charging the one or more walls of the grow module to repel the mist of nutrients.

8. The gardening appliance of claim 1, wherein the grounding assembly is configured for adjusting a charge level of the root end of the plant pod to manipulate the electrostatic attraction between the plant pod and the mist of nutrients.

9. The gardening appliance of claim 1, wherein the electrostatic charging assembly is electrically coupled to the plant pod for selectively charging the root end of the plant pod to repel the mist of nutrients.

10. The gardening appliance of claim 1, wherein the grow module defines a plurality of apertures, the plurality of apertures being configured for receiving a plurality of plant pods that grow a plurality of plants, and wherein the grounding assembly is configured for selectively grounding a portion of the plurality of plant pods to urge the mist of nutrients toward the portion of the plurality of plant pods.

11. The gardening appliance of claim 1, wherein the hydration system comprises:
a liquid pump fluidly coupled to a mixing tank for receiving a flow of nutrients.

12. The gardening appliance of claim 1, wherein the hydration system further comprises:
an air pump fluidly coupled to the discharge nozzle.

13. The gardening appliance of claim 1, wherein the mist of nutrients comprises high pressure atomized and ionized fluid or mist comprising water and nutrients.

14. A hydration system for a gardening appliance, the gardening appliance comprising a grow module defining a pod aperture for receiving a plant pod, the hydration system comprising:
a discharge nozzle for selectively spraying a mist of nutrients into a grow chamber;
a grounding assembly configured for electrically grounding a root end of the plant pod when then plant pod is inserted through the pod aperture; and
an electrostatic charging assembly operably coupled to the discharge nozzle for selectively charging the mist of nutrients such that the mist of nutrients is attracted to the root end of the plant pod.

15. The hydration system of claim 14, wherein the plant pod is formed at least partially from a conductive contact, and wherein the grounding assembly further comprises:
a grounding contact positioned adjacent the pod aperture for contacting the conductive contact of the plant pod when the plant pod is inserted through the pod aperture.

16. The hydration system of claim 14, further comprising:
a pod receptacle attached to the grow module adjacent the pod aperture for receiving the plant pod, the pod receptacle being operably coupled to the grounding assembly.

17. The hydration system of claim 14, wherein the electrostatic charging assembly is electrically coupled to one or more walls of the grow module for selectively charging the one or more walls of the grow module to repel the mist of nutrients.

18. The hydration system of claim 14, wherein the grounding assembly is configured for adjusting a charge level of the root end of the plant pod to manipulate the electrostatic attraction between the plant pod and the mist of nutrients.

19. The hydration system of claim 14, wherein the grow module defines a plurality of apertures, the plurality of apertures being configured for receiving a plurality of plant pods that grow a plurality of plants, and wherein the grounding assembly is configured for selectively grounding a portion of the plurality of plant pods to urge the mist of nutrients toward the portion of the plurality of plant pods.

20. The hydration system of claim 14, further comprising:
a liquid pump fluidly coupled to a mixing tank for receiving a flow of nutrients; and
an air pump fluidly coupled to the discharge nozzle.
